(19) United States
(12) Patent Application Publication
(10) Pub. No.: US 2023/0325532 A1
(43) Pub. Date: Oct. 12, 2023

(54) CONTEXTUAL APP PROTECTION FOR COLLABORATION SESSIONS

(71) Applicant: CITRIX SYSTEMS, INC., FORT LAUDERDALE, FL (US)

(72) Inventors: Manbinder Pal SINGH, Coral Springs, FL (US); SANTOSH GUMMUNUR CHIRANJEEVI SAMPATH, ULSOOR BANGALORE (US)

(21) Appl. No.: 17/658,877

(22) Filed: Apr. 12, 2022

(51) Int. Cl. G06F 21/62; G06F 9/451; H04L 65/401

(52) U.S. Cl. CPC G06F 21/629; G06F 9/452; G06F 21/6218; H04L 65/4015

(57) ABSTRACT

SEQ CHAPTER \h \r 1 SEQ CHAPTER \h \r 1 SEQ CHAPTER \h \r 1 SEQ CHAPTER \h \r 1A computing system includes a virtual server providing virtual computing sessions to be accessed by client computing devices. Collaboration apps operating in the virtual computing sessions allow users to participate in a collaboration session with other users. Each client computing device includes a processor to enable app protection to prevent an unauthorized transfer of data by a user of the client computing device when participating in a collaboration session. The virtual server determines when the user of one of the client computing devices is to be a presenter within the collaboration session, and in response to one of the users being the presenter while the other users are non-presenters, the virtual computing session disables app protection in the presenter's client computing device for the presenter to share their screen with the non-presenters.

### TECHNICAL FIELD

The present disclosure relates to computing systems, and more particularly, to preventing the unauthorized transfer of data in a collaboration session.

### BACKGROUND

Many organizations are now using application and/or desktop virtualization to provide a more flexible option to address the varying needs of their users. In desktop virtualization, a user's operating system, applications, and/or user settings may be separated from the user's physical smartphone, laptop, or desktop computer.

Using client-server technology, a virtualized desktop may be stored in and administered by a remote server, rather than in the local storage of a computing device. The computing device accesses the virtualized desktop in a remote computing session with the server. The remote computing session allows a user to access resources. The resources, for example, include SaaS and web apps, desktops, files and data. At times, a user may access a collaboration app in order to share their screen with other users within the organization while participating in a collaboration session.

### SUMMARY

A computing system includes a virtual server and a plurality of client computing devices. The virtual server is configured to provide a plurality of virtual computing sessions, each virtual computing session configured to provide a collaboration app that allows a user to participate in a collaboration session with other users.

The plurality of client computing devices are configured to access the plurality of virtual computing sessions via a communications network for the users to participate in the collaboration session. Each client computing device includes a display, and a processor coupled to the display. The processor enables app protection to prevent an unauthorized transfer of data by a user of the client computing device, and launches the collaboration app within the virtual computing session being accessed for the user to participate in the collaboration session with the other users.

The virtual server is further configured to monitor for when the user of one of the client computing devices is to be a presenter within the collaboration session. In response to one of the users being the presenter while the other users are non-presenters, the virtual computing session disables app protection in the presenter's client computing device for the presenter to share their display screen with the non-presenters.

Each virtual computing session may uses a screen share intent detector to monitor for when the user of one of the client computing devices is to be the presenter. The screen share intent detector may be based on user interface (UI) automation or based on code loaded into each launched collaboration app.

The user of one of the client computing devices is to be the presenter based on the user selecting share screen within the collaboration app running in their virtual computing session.

The virtual server may be further configured to verify that the presenter is authorized to be the presenter before disabling app protection. The virtual server may use a policy database to determine that the presenter is authorized.

Only one user can be a presenter at a time within the collaboration session. The virtual server may be further configured to disable app protection for a new presenter while enabling app protection for the user that was previously the presenter.

Audio/video screen sharing traffic is offloaded from the virtual server to the plurality of computing devices for peer-to-peer communications.

The virtual server may be further configured to deny one of the client computing devices into the collaboration session in response to a local collaboration app being launched on the client computing device instead of launching the collaboration app in the virtual computing session.

The unauthorized transfer of data includes at least one of display screen sharing, display screen recording and taking display screen shots.

Another aspect is directed to a virtual server comprising a processor configured to provide a plurality of virtual computing sessions to be accessed by a plurality of client computing devices, with each client computing device having app protection enabled to prevent an unauthorized transfer of data by a user of the client computing device.

The processor launches a collaboration app within each corresponding virtual computing session in response to user input, with the collaboration app allowing the user to participate in the collaboration session with other users. The processor monitors for when the user of one of the client computing devices is to be a presenter within the collaboration session while the other users are non-presenters. In response to one of the users being the presenter, app protection is disabled by the processor in the presenter's client computing device for the presenter to share their display screen with the non-presenters.

Yet another aspect is directed to a method for operating the virtual server as described above.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computing system that provides contextual app protection for collaboration sessions according to aspects of the disclosure.

FIG. 7 is a flow diagram on operating the computing system illustrated in FIG. 6.

FIG. 8 is a flow diagram on operating the virtual server within the computing system illustrated in FIG. 6.

FIG. 9 is a flow diagram on operating one of the client computing devices within the computing system illustrated in FIG. 6.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout, and prime notation is used to indicate similar elements in different embodiments.

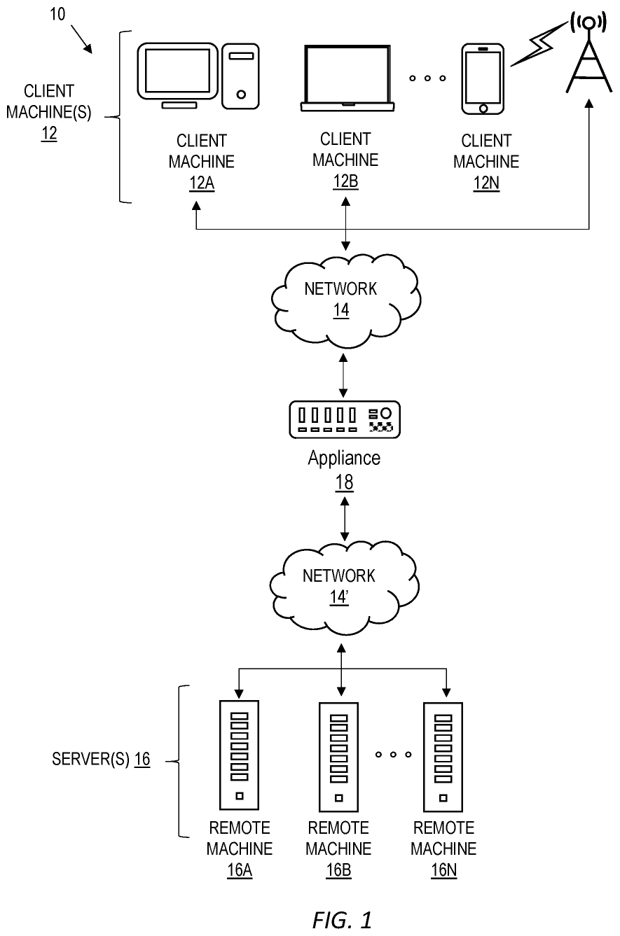

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′. In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 18 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

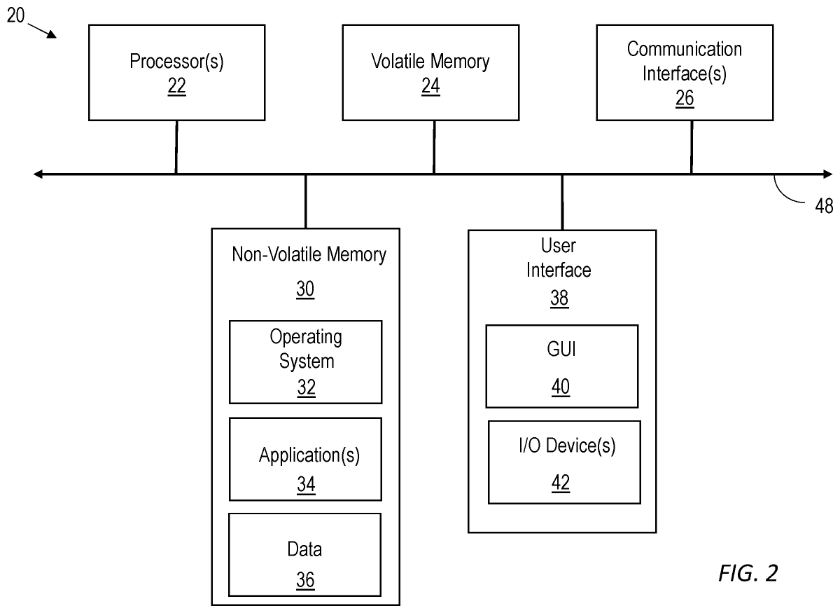

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Florida (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

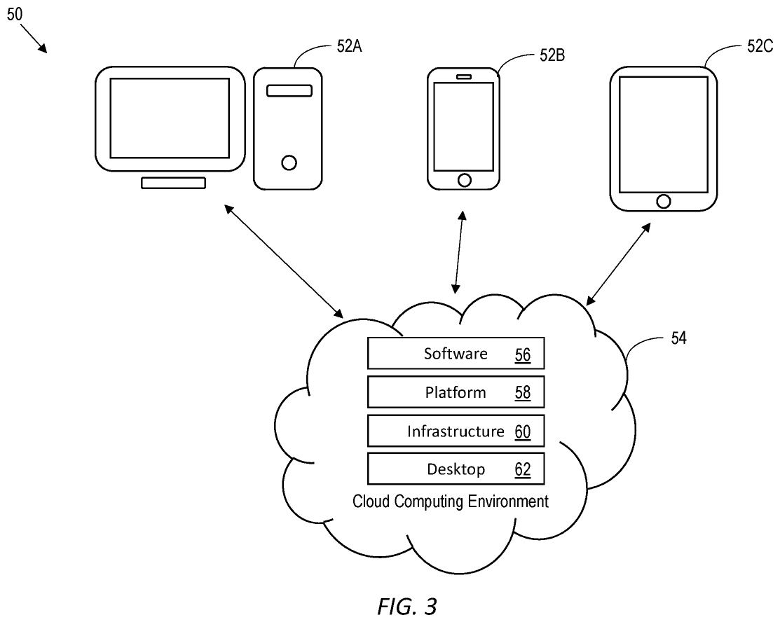

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft ONEDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

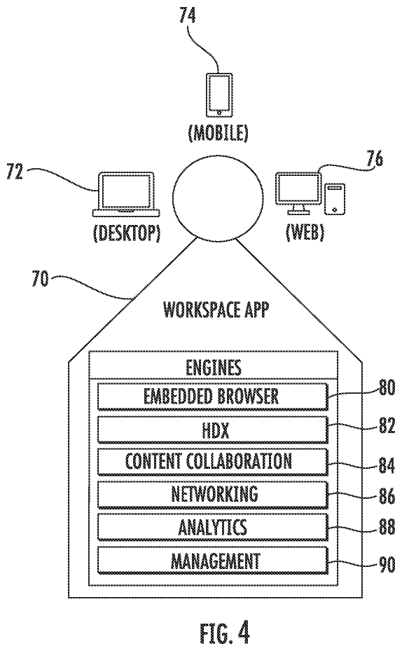

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific p-VPN connection. A p-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing counter-measures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

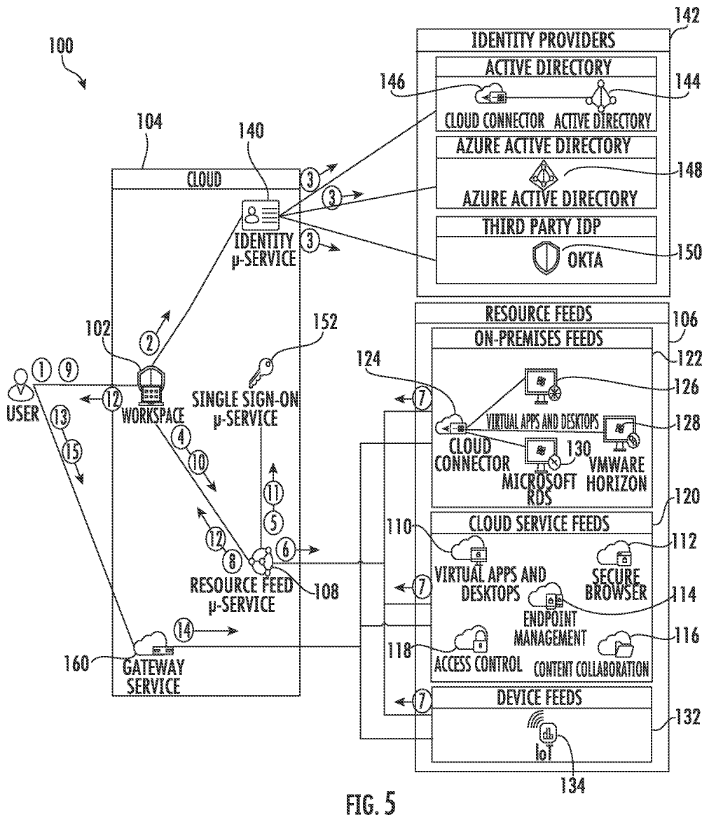

Referring now to FIG. 5, a workspace network environment 100 providing a unified experience to a user based on the workspace app 70 will be discussed. The desktop, mobile and web versions of the workspace app 70 all communicate with the workspace experience service 102 running within the Citrix Cloud 104. The workspace experience service 102 then pulls in all the different resource feeds via a resource feed micro-service 108. That is, all the different resources from other services running in the Citrix Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Citrix Cloud 104, and presenting their identity (event 1). The identity includes a user name and password, for example.

The workspace experience service 102 forwards the user's identity to an identity micro-service 140 within the Citrix Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Citrix Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

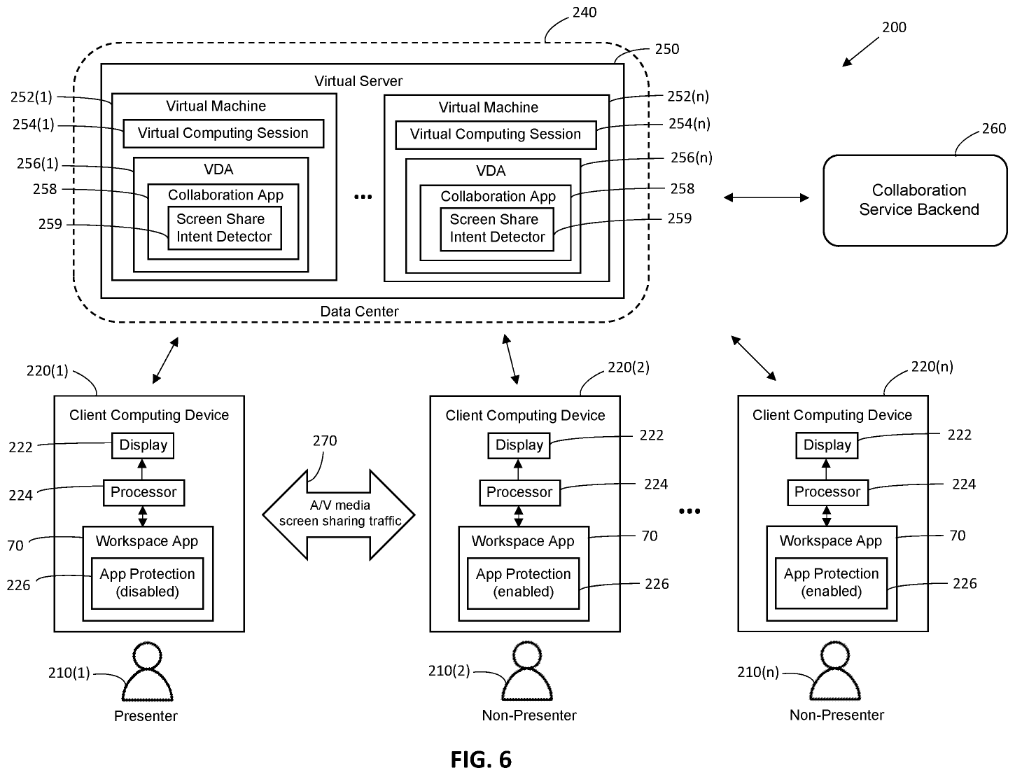

Referring now to FIG. 6, a computing system 200 providing collaboration sessions for users 210(1)-210(n) within an organization or enterprise will be discussed. A collaboration service backend 260 interfacing with a data center 240 allows the users 210(1)-210(n), which may be generally referred to as users 210, to participate in the collaboration sessions.

Collaboration sessions provide screen sharing and video conferencing in real-time for the users 210. Example collaboration services provided by the collaboration service backend 260 include Microsoft (MS) Teams as provided by Microsoft, Webex as provided by Cisco, and GoToMeeting as provided by LogMeIn.

To prevent data exfiltration, which is the unauthorized transfer of data, app protection 226 is initially enabled on each of the client computing devices 220(1)-220(n). Client computing devices 220(1)-220(n) may be generally referred to as client computing devices 220. App protection 226 is advantageous within an organization that deals with sensitive information that needs to be protected. An example app protection 226 is Citrix App Protection.

App protection 226, when enabled, prevents users 210 from sharing their screen, from recording their screen, and from taking screenshots. App protection 226 also protects against keyloggers, which involves a logging program (i.e., malware) used to record the keys struck on a keyboard so that a person using the keyboard is unaware that their actions are being monitored. Data can then be retrieved by the person operating the logging program.

However, app protection 226 is counterintuitive or contradictory to collaboration sessions where screen sharing is needed. A workaround is to allow exceptions by disabling app protection 226 during collaboration sessions. However, a shortcoming of this approach is that any of the participants (e.g., an insider threat) in the collaboration session can still initiate data exfiltration.

As will be discussed in detail below, the computing system 200 allows app protection 226 to be disabled or enabled for a client computing device 220 based on the context of the user 210 of the client computing device 220 intending to share their display screen 222 within a collaboration session. That is, app protection 226 is disabled for a user 210(1), who is a presenter within a collaboration session, in order to share their screen with the other users 210(2)-210(n) participating in the collaboration session, but with the other users 210(2)-210(n) having app protection 226 enabled to prevent sharing or recording of their screens. The other users 210(2)-210(n) may be referred to as non-presenters or attendees within the collaboration session.

Still referring to FIG. 6, the computing system 200 includes a virtual server 250 operating within the data center 240. The virtual server 250 includes virtual machines 252(1)-252(n) providing virtual computing sessions 254(1)-254(n) to be accessed by the client computing devices 220(1)-220(n) via a communications network. The virtual machines 252(1)-252(n) may be generally referred to as virtual machines 252, and the virtual computing sessions 254(1)-254(n) may be generally referred to as virtual computing sessions 254.

Virtual delivery appliances (VDAs) 256(1)-256(n) are associated with the virtual machines 252(1)-252(n). The virtual delivery appliances 256(1)-256(n) may be generally referred to as virtual delivery appliances 256. Each client device 220 will have a virtual machine 252 and a corresponding virtual delivery appliance 256 assigned thereto.

The virtual delivery appliances 256 are software installed on the virtual machines 252 running in the virtual server 250. The virtual machines 252 provide the virtual computing sessions 254, and the virtual delivery appliances 256 make the virtual computing session 254 remotely available to a client computing device 220. The virtual delivery appliances 256 may be a Citrix Virtual Delivery Agent (VDA), for example.

Each virtual delivery appliance 256 is configured to provide a collaboration app 258 that allows a user 210 to participate in a collaboration session with other users 210 within the organization. The collaboration app 258, when launched by the user 210, is running within the data enter 240 in a remote session, i.e., a virtual computing session 254. Authentication of the user 210 launching the collaboration app 258 is between the remote session and the collaboration service backend 260.

The collaboration sessions may be optimized so that audio/video screen sharing is offloaded to the end points (i.e., at the client computing devices 220), instead of in the remote session. By optimizing the collaboration sessions so that audio/video screen sharing is directly on the client computing devices 220, use of the resources in the VDAs 256 are reduced. In other words, the bulk of the data transfer that happens during screen sharing in a collaboration session is between the client computing devices 220 (i.e., peer-to-peer) instead of in the VDA 256.

In one embodiment, Citrix HDX may be used to provide collaboration session optimization. The optimization is based on Web Real-Time Communications (WebRTC), which is a free and open-source project providing web browsers and mobile applications with real-time communication via application programming interfaces (APIs). Although not illustrated, HDX Teams Services (e.g., WebSocketService.exe and WebSocketAgent.exe) within the VDAs 256 communicate with an HDX embedded media engine within each client computing device 220.

With optimization, part of the real-time media application code is run in the data center 240. Redirection of WebRTC APIs provides a way for the real-time media application code to continue executing on the virtual server 250 while offloading real-time media processing and networking to the client computing devices 220. The real-time media application code can be largely unaware of the fact that WebRTC APIs are being redirected, resulting in real-time media optimization for the virtual computing sessions 254.

A screen share intent detector 259 is used by the resources in each VDA 256 to monitor for when the user 210 of one of the client computing devices 220 is to be a presenter within the collaboration session. The screen share intent detector 259 monitors for when one of the users 210 selects share screen within the collaboration app 258 running in their virtual computing session 254.

In one embodiment, the screen share intent detector 259 is based on user interface (UI) automation. In another embodiment, the screen share intent detector 259 is based on code loaded or injected into each launched collaboration app 258. The injected code may be javascript code, for example.

In response to the user 210(1) being a presenter while the other users 210(2)-210(n) are non-presenters, the VDA 256(1) supporting the virtual computing session 254(1) disables app protection 226 in the presenter's client computing device 220(1) for the presenter 210(1) to share their screen with the non-presenters 210(2)-210(n). App protection 226 is disabled by the VDA 256(1) sending a disable command to the presenter's client computing device 220(1) over a virtual channel.

With app protection 226 disabled, the presenter 210(1) is able to share their screen as well as being able to take screen shots and to record their screen. With app protection 226 remaining enabled for the non-presenters 210(2)-210(n), they are able to view the shared screen from the presenter 210(1) but cannot record their screen or take screenshots. In addition, the non-presenters 210(2)-210(n) cannot launch a separate collaboration session on their own in order to record the shared screen from the presenter 210(1) while in the separate collaboration session.

Each client computing device 220 includes a display 222, a processor 224 coupled to the display, and a workspace app 70 executed by the processor 312. The display 222 may also be referred to as a display screen. As discussed above, the workspace app 70 is how a user gets access to their workspace resources within an organization, which includes applications and desktops, for example.

The workspace app 70 allows the user of the client computing device 220 to launch the collaboration app 258 on the virtual machine 252 assigned to the client computing device 220. Generally, the workspace app 70 enables app protection 226 on the client computing device 220 in response to the user 210 logging into the client computing device 220 to prevent any unauthorized transfer of data by the user 210.

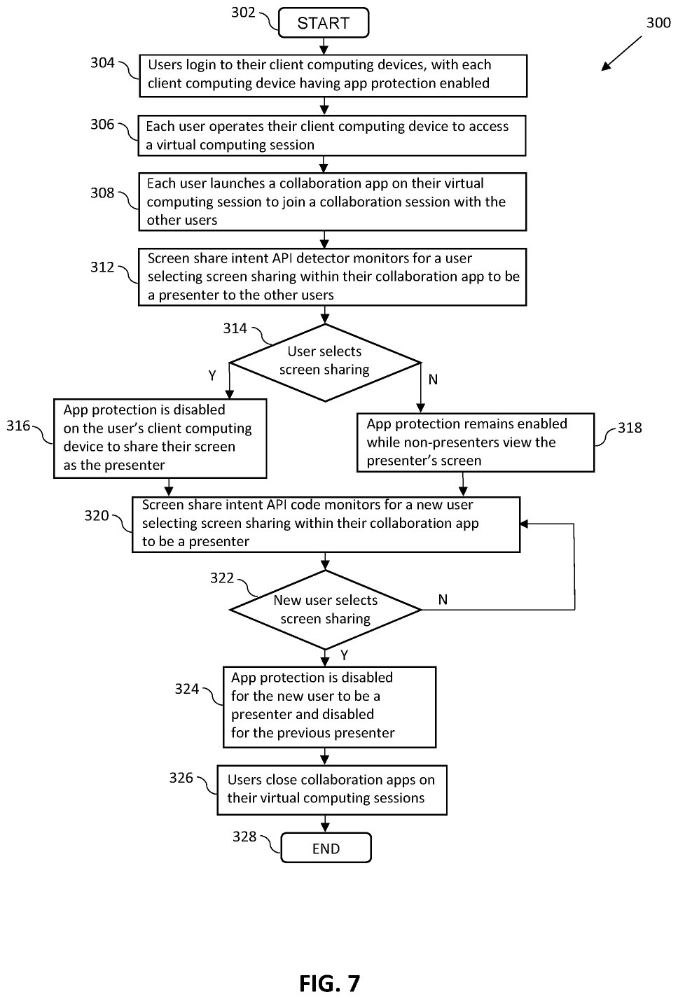

Referring now to FIG. 7, a flow diagram 300 for operating the computing system 200 will be discussed. From the start (Block 302), the users 210 log into their respective client computing devices 220 at Block 304. Each client computing device 220 will have app protection enabled 226.

App protection 226 within an organization advantageously allows the organization to prevent data exfiltration of sensitive or classified data by users 210 within the organization. With app protection 226 enabled, if a user tried to share or record their display screen 222, then a blank or black screen would be viewed or recorded.

Each user 210 operates their client computing device 220 to access a virtual computing session 254 at Block 306. To join a collaboration session, each user 210 launches the collaboration app 258 on their virtual computing session 254 at Block 308. The collaboration app 258 may be MS Teams, for example. The launched collaboration apps 258 interface with the collaboration service backend 260. As an example, the collaboration service backend 260 may be Microsoft Azure, which is a cloud computing service operated by Microsoft for application management via Microsoft-managed data centers.

The collaboration service backend 260 authenticates and keeps track of the users 210 that are to participate in the collaboration session. This is done in the remote session. The collaboration service backend 260 also provides instant messaging (IM) between the users 210 over a common network.

To reduce the resources used by the collaboration apps 258 within the VDAs 256 during the collaboration session, optimization of the collaboration app 258 may be implemented. As discussed above, the optimization allows for audio/video screen sharing traffic 270 to be passed directly between the client devices 220 without having to route the traffic through the remote session in the data center 240. For example, Citrix HDX technology, as also discussed above, may be used to provide the optimization.

Each launched collaboration app 258 has a screen share intent detector 259 associated therewith. The screen share intent detector 259 is configured to monitor for a user selecting screen sharing within their collaboration app 258 at Block 312 in order for the user to share their display screen 222 as a presenter.

The screen share intent detector 259 may be based on user interface (UI) automation or code loaded into each launched collaboration app 258. Since the collaboration apps 258 are running in the virtual computing sessions 254, the monitoring is done within the data center 240 and not on the client computing devices 220.

In decision Block 314, a determination is made on if a user 210 selects screen sharing. Administration within the organization may implement policies within the data center 240 on which users 210 can and cannot be a presenter. If an intended presenter is not authorized, then the user is not able to share their display screen 222.

The virtual server 250 verifies that the presenter 210(1) is authorized to be the presenter before disabling app protection 226. The virtual server 250 may use a policy database to determine that the presenter is authorized. For example, if sensitive information under a non-disclosure agreement (NDA) is to be discussed, then the number of presenters may be limited. One authorized presenter may be the project manager organizing the collaboration session, and another authorized presenter may be the lead engineer in charge of the technology that is under the NDA.

In response to a user 210(1) selecting screen sharing within their launched collaboration app 258 in Block 316, app protection 226 is disabled on the user's client computing device 220(1). The virtual computing session 254(1) provides a disable command over a virtual channel to the client computing device 220(1). For the non-presenters 210(2)-210(n), app protection remains enabled at Block 318.

With app protection 226 disable on the presenter's 210(1) client computing device 220(1), the presenter is able to share their display screen 222 with the non-presenters 210(2)-210(n). The presenter 210(1) is able to record their display screen 222 and take screen shots if needed.

With app protection 226 enabled on the non-presenters' 210(2)-210(n) client computing device 220(2)-220(n), the non-presenters are able to view the presenter's 210(1) display screen 222. However, the non-presenters 210(2)-210(n) cannot record their display screen 222 or take screen shots. Also, as noted above, the non-presenters 210(2)-210(n) cannot open a new collaboration app 258 in order to record the shared display screen 222.

The screen share intent API code 259 in each virtual computing session 254 continues to monitor at Block 320 for a new user selecting share display screen 222 within their collaboration app 258 in order to be a presenter. In decision Block 322, a determination is made on if a new user 210 selects screen sharing.

If a new user does not select share display screen 222 within the collaboration session, then the flow diagram 300 loops back to Block 320 to continue monitoring. If a new user does select share display screen 222 within the collaboration session, then app protection 226 is disabled in Block 324 for the new presenter and app protection 226 is enabled for the previous presenter since there can be only one presenter at a time. At Block 326, in response to the users closing their collaboration apps 258, the collaboration session is stopped. The flow diagram ends at Block 328.

The computing system 200 as discussed above is based on the collaboration apps 258 running in the virtual computing sessions 254. That is, the collaboration apps 258 are centralized in the data center 240. Centralized collaboration apps 258 allow the data center 240 to keep track of the users 210 participating in the collaboration sessions.

In response to one of the client computing devices 220 launching a local collaboration app 258 instead of launching the centralized collaboration app 258 in the virtual computing session 254, the data center 240 may deny the client computing device 220 into the collaboration session. The data center 240 may send a message to the denied user to use the collaboration app 258 in the virtual server 250 to join the collaboration session.

Alternatively, for the client computing device 220 with the launched localized collaboration app to particulate in the collaboration session, code would need to be injected into the localized collaboration app that would allow control of screen sharing within the launched localized collaboration app.

There can only be one presenter at a time, and if there is already a presenter, then the virtual computing session 254 being accessed by the client computing device 220 with the launched localized collaboration app would send a command to prevent screen sharing.

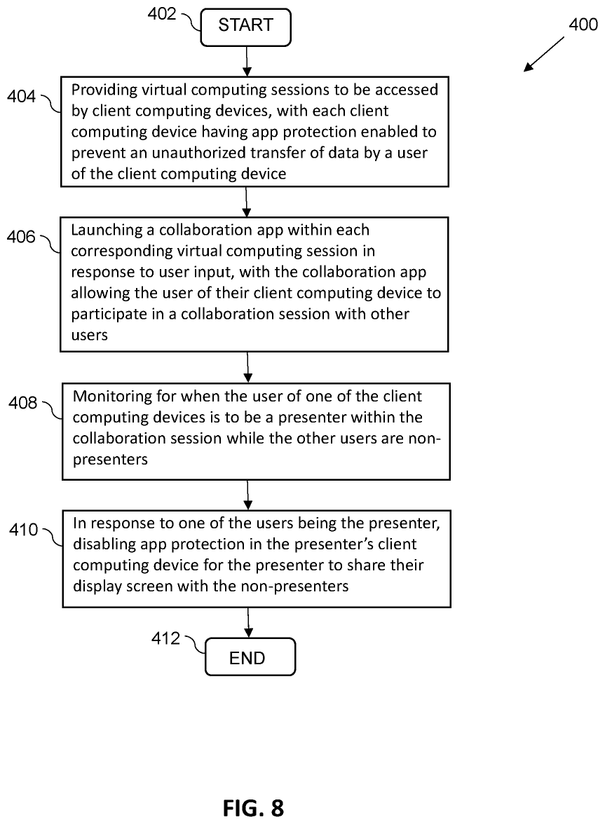

Referring now to FIG. 8, a flow diagram 400 from the perspective of the virtual server 250 operating within the computing system 200 will be discussed. From the start (Block 402), virtual computing sessions 254 are to be accessed by client computing devices 220 at Block 404, with each client computing device 220 having app protection 226 enabled to prevent a user 210 of the client computing device 220 from performing an unauthorized transfer of data.

A collaboration app 258 is launched at Block 406 within each corresponding virtual computing session 254 in response to user input. The collaboration app 258 allows the user to participate in a collaboration session with other users.

Monitoring is performed at Block 408 for when the user 210(1) of one of the client computing devices 220(1) is to be a presenter within the collaboration session while the other users 210(2)-210(n) are non-presenters. In response to one of the users 210(1) being a presenter, app protection 226 is disabled in the presenter's client computing device 220(1) at Block 410 for the presenter to share their display screen with the non-presenters 210(2)-210(n). The method ends at Block 412.

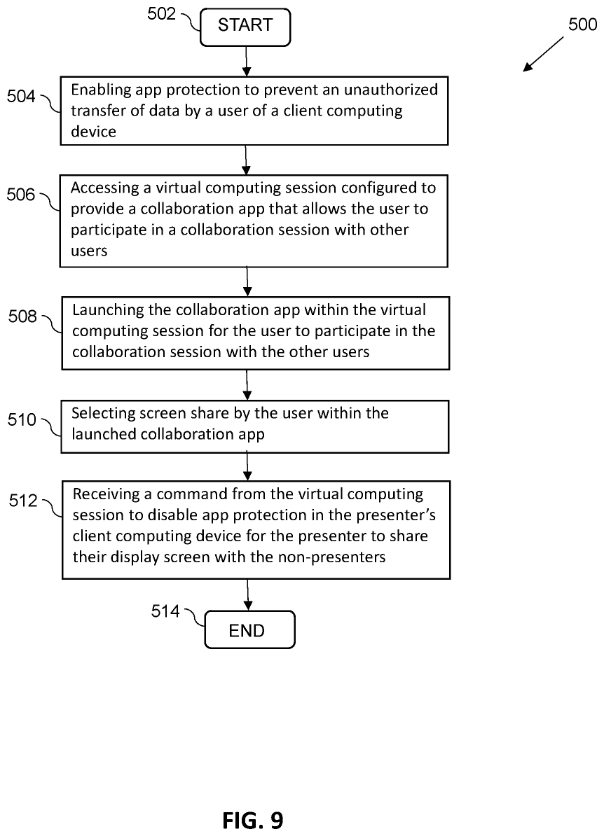

Referring now to FIG. 9, a flow diagram 500 from the perspective of the client computing device 220 operating within the computing system 200 will be discussed. From the start (Block 502), app protection 226 is enabled at Block 504 to prevent a user 210 of the client computing device 220 from performing an unauthorized transfer of data.

A virtual computing session 254 configured to provide a collaboration app 258 that allows the user 210 to participate in a collaboration session with other users 210 is accessed at Block 506. At Block 508, the collaboration app 258 is launched within the virtual computing session 25 for the user 210 to participate in the collaboration session with the other users 210. At Block 510, the user 210 of the client computing device 220 selects screen share within the launched collaboration app 258

A command is received at Block 512 from the virtual computing session 254 to disable app protection 226 in the presenter's client computing device 220(1) for the presenter 210(1) to share their display screen with the non-presenters 210(2)-210(n). The method ends at Block 514.

Furthermore, other aspects of the virtual server 250 or the client computing device 220 may take the form of a computer program product stored by one or more computer-readable storage media having computer-readable program code, or instructions, embodied in or on the storage media, for operation thereof. Any suitable computer readable storage media may be utilized, including hard disks, CD-ROMs, optical storage devices, magnetic storage devices, and/or any combination thereof.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A computing system comprising:
a virtual server configured to provide a plurality of virtual computing sessions, each virtual computing session configured to provide a collaboration app that allows a user to participate in a collaboration session with other users; and
a plurality of client computing devices configured to access the plurality of virtual computing sessions via a communications network for the users to participate in the collaboration session, with each client computing device comprising:
a display, and
a processor coupled to said display and configured to perform the following:
enable app protection to prevent an unauthorized transfer of data by a user of said client computing device, and
launch the collaboration app within the virtual computing session being accessed for the user to participate in the collaboration session with the other users;
said virtual server is further configured to monitor for when the user of one of said client computing devices is to be a presenter within the collaboration session, and in response to one of the users being the presenter while the other users are non-presenters, the virtual computing session disables app protection in the presenter's client computing device for the presenter to share their display screen with the non-presenters.

2. The computing system according to claim 1 wherein each virtual computing session uses a screen share intent detector to monitor for when the user of one of said client computing devices is to be the presenter.

3. The computing system according to claim 2 wherein the screen share intent detector is based on user interface (UI) automation.

4. The computing system according to claim 2 wherein the screen share intent detector is based on code loaded into each launched collaboration app.

5. The computing system according to claim 1 wherein the user of one of said client computing devices is to be the presenter based on the user selecting share screen within the collaboration app running in their virtual computing session.

6. The computing system according to claim 1 wherein said virtual server is further configured to verify that the presenter is authorized to be the presenter before disabling app protection.

7. The computing system according to claim 6 wherein said virtual server uses a policy database to determine that the presenter is authorized.

8. The computing system according to claim 1 wherein only one user can be a presenter at a time within the collaboration session.

9. The computing system according to claim 8 wherein said virtual server is further configured to disable app protection for a new presenter while enabling app protection for the user that was previously the presenter.

10. The computing system according to claim 1 wherein audio/video screen sharing traffic is offloaded from said virtual server to said plurality of computing devices for peer-to-peer communications.

11. The computing system according to claim 1 wherein said virtual server is further configured to deny one of said client computing devices into the collaboration session in response to a local collaboration app being launched on said client computing device instead of launching the collaboration app in the virtual computing session.

12. The computing system according to claim 1 wherein the unauthorized transfer of data includes at least one of display screen sharing, display screen recording and taking display screen shots.

13. A virtual server comprising:
a processor configured to perform the following:
provide a plurality of virtual computing sessions to be accessed by a plurality of client computing devices, with each client computing device having app protection enabled to prevent an unauthorized transfer of data by a user of the client computing device,
launch a collaboration app within each corresponding virtual computing session in response to user input, with the collaboration app allowing the user to participate in the collaboration session with other users,
monitor for when the user of one of the client computing devices is to be a presenter within the collaboration session while the other users are non-presenters, and
in response to one of the users being the presenter, disable app protection in the presenter's client computing device for the presenter to share their display screen with the non-presenters.

14. The virtual server according to claim 13 wherein each virtual computing session uses a screen share intent detector to monitor for when the user of one of the client computing devices is to be the presenter.

15. The virtual server according to claim 14 wherein the screen share intent detector is based on at least one of user interface (UI) automation and code loaded into each launched collaboration app.

16. The virtual server according to claim 13 wherein said processor is further configured to disable app protection for a new presenter while enabling app protection for the user that was previously the presenter.

17. The virtual server according to claim 13 wherein said processor is further configured to offload audio/video screen sharing traffic to the plurality of computing devices for peer-to-peer communications.

18. A method comprising:
providing a plurality of virtual computing sessions to be accessed by a plurality of client computing devices, with each client computing device having app protection enabled to prevent an unauthorized transfer of data by a user of the client computing device;
launching a collaboration app within each corresponding virtual computing session in response to user input, with the collaboration app allowing the user to participate in the collaboration session with other users;
monitoring for when the user of one of the client computing devices is to be a presenter within the collaboration session while the other users are non-presenters; and
in response to one of the users being the presenter, disabling app protection in the presenter's client computing device for the presenter to share their display screen with the non-presenters.

19. The method according to claim 18 wherein each virtual computing session uses a screen share intent detector to monitor for when the user of one of the client computing devices is to be the presenter, with the screen share intent detector being based on at least one of user interface (UI) automation and code loaded into each launched collaboration app.

20. The method according to claim 18 further comprising disabling app protection for a new presenter while enabling app protection for the user that was previously the presenter.
